(19) United States
(12) Patent Application Publication
(10) Pub. No.: US 2010/0107864 A1
(43) Pub. Date: May 6, 2010

(54) ELECTRO-HYDRAULIC DOUBLE-ROD ACTUATING CYLINDER

(76) Inventor: James Allen Bushner, Allentown, PA (US)

Correspondence Address: James Allen Bushner, 131 Woodcrest Circle, Allentown, PA, 18103, US

(21) Appl. No.: 12/581,114

(22) Filed: Oct. 16, 2009

Related U.S. Application Data
(60) Provisional application No. 61/106,149, filed on Oct. 16, 2008.

(51) Int. Cl. F15B 13/042

(52) U.S. Cl. 91/422; 60/459

(57) ABSTRACT

A double-rod electrohydraulic actuator for the purpose of causing push-pull motion while being part of a structure. Actuator comprises of a piston assembly and an external cylinder. Piston assembly comprises of a piston housing and flanged piston rods on both ends. Piston housing comprises of a cylindrical housing with external sliding seals in sealing contact with the interior surface of the external cylinder. Cylindrical housing contains: pump, motor, relief valves, seals, and porting required for control of fluid flow through the assembly. External cylinder will have sliding seals at both ends in sealing contact with the flanged piston rods of the piston assembly, and hydraulic fluid filling all internal voids. The flanged piston rods will have porting in the flanges for fluid flow and hollow centers for wiring conduit to and through actuator. Relief valves will bypass fluid around the pump section in overload conditions to protect the actuator.

This is a continuation of provisional application Ser. No. 61106149 filed Oct. 16, 2008.

### FIELD OF THE INVENTION

This invention relates to an electrically powered hydraulic actuating cylinder with a double-rod piston for the purpose of causing a push-pull type motion while being part of the structure, framework, or skeleton of robotic, mobile or stationary equipment. The invention requires both piston rods to be of equal diameter, with at least one rod to be a hollow shaft for the purpose of conduit for the electrical wiring to the unit for power and sensors. The invention builds on the prior art of the single rod electro-hydraulic actuating cylinder (which incorporate a complete hydraulic system including a bi-directional motor and bi-directional pump built inside the internal double acting piston with pressure relieving valves to limit forces, ref. FIG. 1 of U.S. Pat. No. 2,918,795, Melvin W. Marion), and the invention has the advantage of equal cross sectional areas on both sides of the piston which eliminates the need for venting or internal accumulators to account for changes of volume during the motion of the piston assembly in the cylinder and thus making the invention suitable for high pressure or low pressure applications.

The invention is suitable for use as part of a structure, with the piston and rod assembly functioning as a beam, and the external cylinder as the movable element on the beam. This assembly would function similarly to the bone and muscle combination of the human body. This similarity to the human structure makes the invention particularly well suited for artificial limbs and robotic applications.

The invention piston can also be equipped with a through hole so that wiring can pass completely through the center of one actuator assembly with two hollow shaft piston rods and lead to a second assembly (see FIG. 11). With a pivot joint (49) between the two actuators the assembly would be similar to the human leg with the upper muscle or Hamstrings (47), knee (49), and lower muscle or Gastrocnemius muscle (51).

### DESCRIPTION OF THE INVENTION

The invention comprises a piston assemble inside and a hydraulic cylinder assembly. The piston assembly comprises of a Pump Side Rod Shaft (3), a Motor Side Rod Shaft (4), and a Piston Housing Assembly. The Piston Housing Assembly is a cylindrical ported housing with seals on the outside diameter that are in sliding contact with the inside diameter of the Cylinder Assembly, and consists of a motor assembly section and a pump assembly section. The Pump assembly section comprises the pump gears (17, 40), relief valves (23, 24), Pump Rear Housing (10) with the Pump Drive Gear (18). The motor assembly contains the Motor Housing (11) and the motor components: Motor Shaft (20) with the Motor Pinion Gear (19), the Motor Rotor (21) and the Motor Stator (22). The Cylinder Assembly encloses the Piston Housing Assembly and consists of a Cylinder (1), a Pump Side Cylinder Head (7), and a Motor side Cylinder Head (8). Each Cylinder Head contains rod packing (5) that is in sliding contact with the rod shaft on each end of the Piston Housing Assembly. Each Cylinder Head also includes a fill/drain/vent plug (6). The voids of the cylinder and piston assembly are filled with hydraulic fluid. The double-rod design with equal diameter rods of the piston assembly is necessary to maintain constant volume of the cylinder. Wiring to the motor and through the actuator is through the hollow piston shaft on the motor end of the piston.

When the Motor is energized so the Motor Shaft (20) is turning clockwise when looking at the motor from the pinion gear side, the Motor Pinion Gear (19) rotates clockwise and drives the Pump Drive Gear (18) and the Pump Driving Gear (17) to rotate counter clockwise and force hydraulic fluid contained between the gaps between the teeth of the Pump Driving Gear (17) and the inside wall of the gear pump housing (which is in close proximity to the top land of the Pump Driving Gear (17) teeth) and contained on the top by the bottom of the Pump Rear Housing (10) (which is in close proximity to the top face of the Pump Driving Gear (17)) and contained on the bottom by the top of the Pump Housing (2) (which is in close proximity to the bottom face of the Pump Driving Gear (17)), to rotate counter clockwise. The Pump Driven Gear (40) will rotate clockwise and force hydraulic fluid contained in the same way as the Pump Driving Gear (17) to rotate clockwise. The hydraulic fluid will then be forced through the Pump Side Pump Port (32) (since the hydraulic fluid can not pass through the mating of the Pump Driving Gear (17) and the Pump Driven Gear (40)) and exit the Pump Housing (2) and pass through the Pump Side Rod Flange (35) to the Pump Side end of the Cylinder Assembly, and thus causing the Cylinder Assembly to move in the direction of the Pump Side Cylinder Head (7). The movement of the Cylinder Assembly forces hydraulic fluid from the Motor Side Cylinder Head through the Motor Side Pump Ports (33) and through the hollow Motor Shaft (20) to the pump gears. Actuation of the motor in the counter clockwise direction will force hydraulic fluid in the opposite path: from the Pump Side End through the Piston Assembly to the Motor Side End, and cause the Cylinder Assembly to move in the direction of the Motor Side Cylinder Head.

The flow of the fluid will be through a relief valve and bypassing the pump section when the differential pressure across the pumping piston is above the set point of the relief valve. External forces due to an impact caused by a fall or collision may cause the high pressures and resulting relief valve action. The Actuator acts as a shock absorber during these high impact times, and can provide some protection for both the Actuator and the attached structure depending on the orientation of the Actuator at the time of the impact, and the direction of the impact. For example, no protection would be available if the Actuator is at the end of its stroke, and the impulse is in the direction requiring further motion beyond the end of stroke. There are two relief valves: the Pump End to Motor End Pressure Relief Valve (23) for forces or impacts causing motion of the Cylinder Assembly in the direction of the Motor Side Cylinder Head (8) and the Motor End to Pump End Pressure Relief Valve (24) for forces or impacts causing motion of the Cylinder Assembly in the direction of the Pump Side Cylinder Head (7). Relief valve will open and allow flow through the relief valve and bypass the pump section of the Piston Assembly when the Hydraulic force on the relief valve plate exceeds the spring force of the relief valve. Relief valve setting is determined by the spring and the resulting spring forces when the spring is compressed into the relieve valve pocket by tightening the assembly bolts between the Pump Rear Housing (10) and the Pump Housing (2).

The object of the invention was to construct an actuator for a walking robot to be use to assist the disabled. The design criteria for the robot requires lifting loads in excess of 300 lbs up flights of stairs, and maximizing the chances of the robot surviving a fall down the stairs. Most electrical actuators that are capable of handling loads in excess of 300 lbs use ball-screw arrangements, which do not have means to absorb load impulses. This narrowed the solution set to hydraulic systems, but the weight and bulkiness of the valves, manifolds, hoses and power units made standard commercially available hydraulic systems unpractical for mobile applications. This product void led to the development of the invention. A patent search was conducted, and a single rod piston actuator design is shown in U.S. Pat. No. 2,918,795 by Melvin W. Marien, Dec. 29, 1959. However, a double rod piston actuator design is not shown. The double rod design of the present invention has numerous advantages over known designs, which includes: 1) No change in volume when the unit actuates, 2) No vents needed due to no change in volume, 3) Functional in any orientation without spill due to no vents, 4) Functional in large pressure range due to the non-compressible design, 5) Improved heat transfer properties due to the removal of cavities and voids, 6) Ability to use the actuator as part of the structure of a system, 7) Through hole design of the actuator used to protect cables passing through the actuator. While prior art actuator designs may be suitable for their particular purposes, it is believed that the present invention represents a substantial advance in actuator design for use with remote devices and for mobile applications for assisting the disabled and other critical fields, such as search and rescue in dangerous or hostile environments.

### BRIEF DESCRIPTION OF THE DRAWINGS

List of labeled items for FIGS. 1 through 10:

1 Cylinder

2 Pump Housing

3 Pump Side Rod Shaft-Hollow

4 Motor Side Rod Shaft

5 Rod Packing

6 Fill Plugs

7 Pump Side Cylinder Head

8 Motor Side Cylinder Head

9 Cylinder Tie Rods

10 Pump Rear Housing

11 Motor Housing

12 Motor Wires and Feed Through Wires

13 High Pressure Electrical Feed-Through

14 Piston Pressure Rings

15 Piston Rider Ring

16 Piston Assembly Bolts

17 Pump Driving Gear

18 Pump Drive Gear

19 Motor Pinion Gear

20 Motor Shaft

21 Motor Rotor

22 Motor Stator

23 Pump End to Motor End Pressure Relief Valve

24 Motor End to Pump End Pressure Relief Valve

25 Wire Conduit Tubing

26 Tubing Tee Connector

27 Tubing NPT Feed-Through Connector

28 Motor Bearings

29 Pump Shaft and Bearings

30 Pump-End-to-Motor-End Pressure Relief Port (through piston head and pump end rod flange)

31 Motor-End-to-Pump-End Pressure Relief port (through piston head and pump end rod flange)

32 Pump Side Pump Port (through motor end rod flange)

33 Motor Side Pump port (through motor side rod flange)

34 Piston Rod End

35 Pump Side Rod Flange

36 Motor Side Rod Flange

37 Feed Through Wires

38 Motor Wires

39 O-ring Seal

40 Pump Driven Gear

41 Mechanical Connection Example

42 Tubing Elbow Connector

43 Pump Side Rod Shaft—Solid

44 Pump Conduit Hole, Plugged

FIG. 1 is the longitudinal sectional view of the preferred embodiment with the feed-through capability (referred to hereafter as the Feed-through Actuator). FIG. 7 is the invention without the feed-through capability (referred to hereafter as the Non-feed-through Actuator). FIGS. 2 and 8 are the transverse sectional view of the pump sections for the Feed-through Actuator and the Non-feed-through Actuator respectively as located on the longitudinal sectional views. FIGS. 3 and 9 are the transverse sectional view of the motor pinion gear and the pump drive gear arrangement for the respective Actuators. FIG. 4 is the transverse sectional view of the motor side rod flange, which is the same for both Actuators as located on the longitudinal sectional views. FIGS. 5 and 10 are the transverse sectional views of the pump side rod flange for the respective Actuators as located on the longitudinal sectional views. FIG. 6 is a longitudinal partial sectional view of the relief valve section, which is the same for both Actuators as located on the transverse sectional views of FIGS. 3 and 9. FIG. 11 is an application example showing an arrangement of two of the Feed-through Actuator joined by joints and linkages.

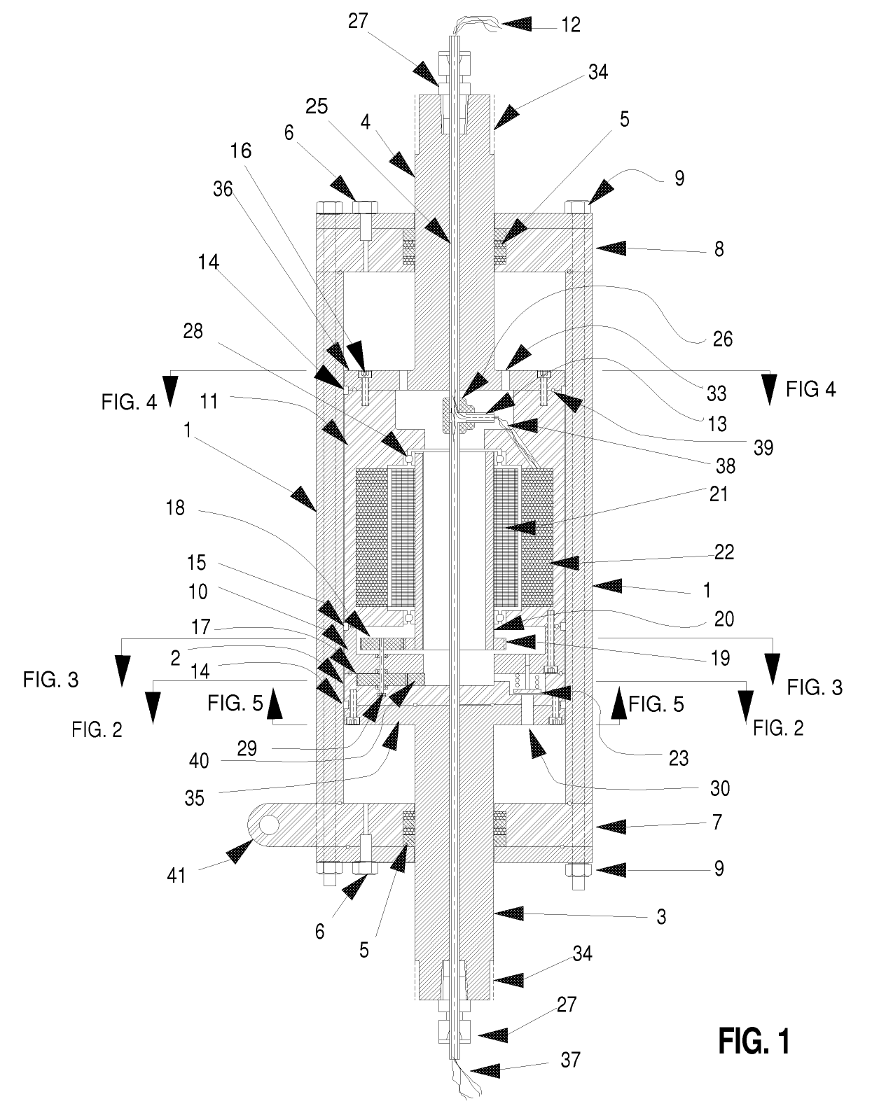

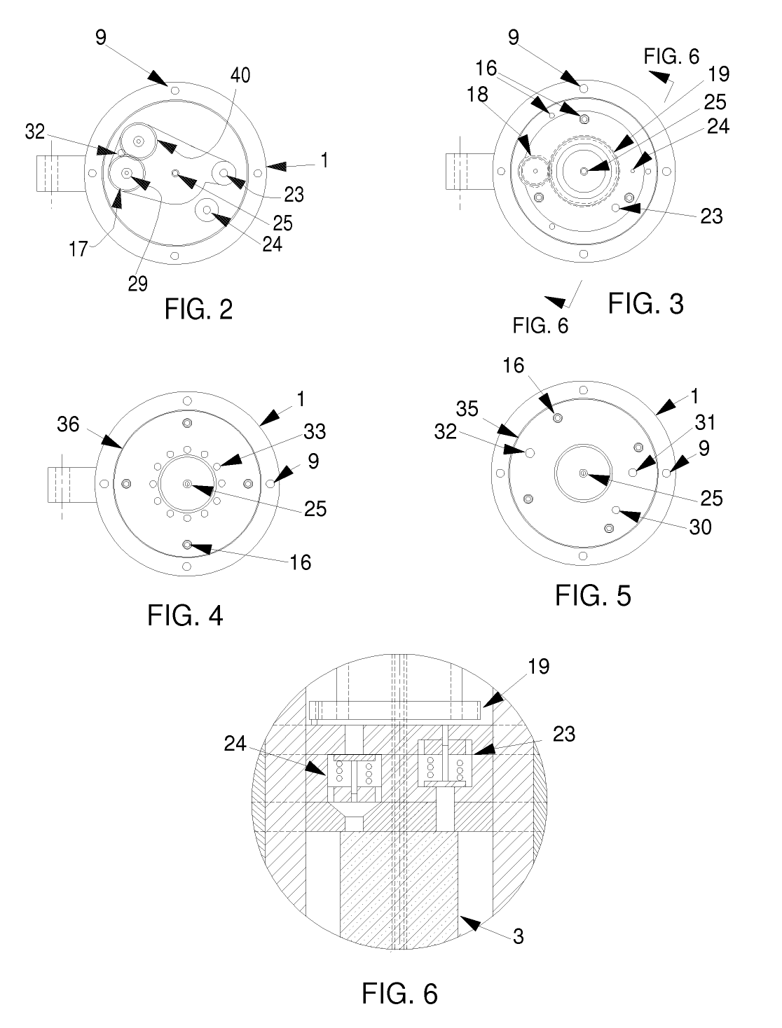

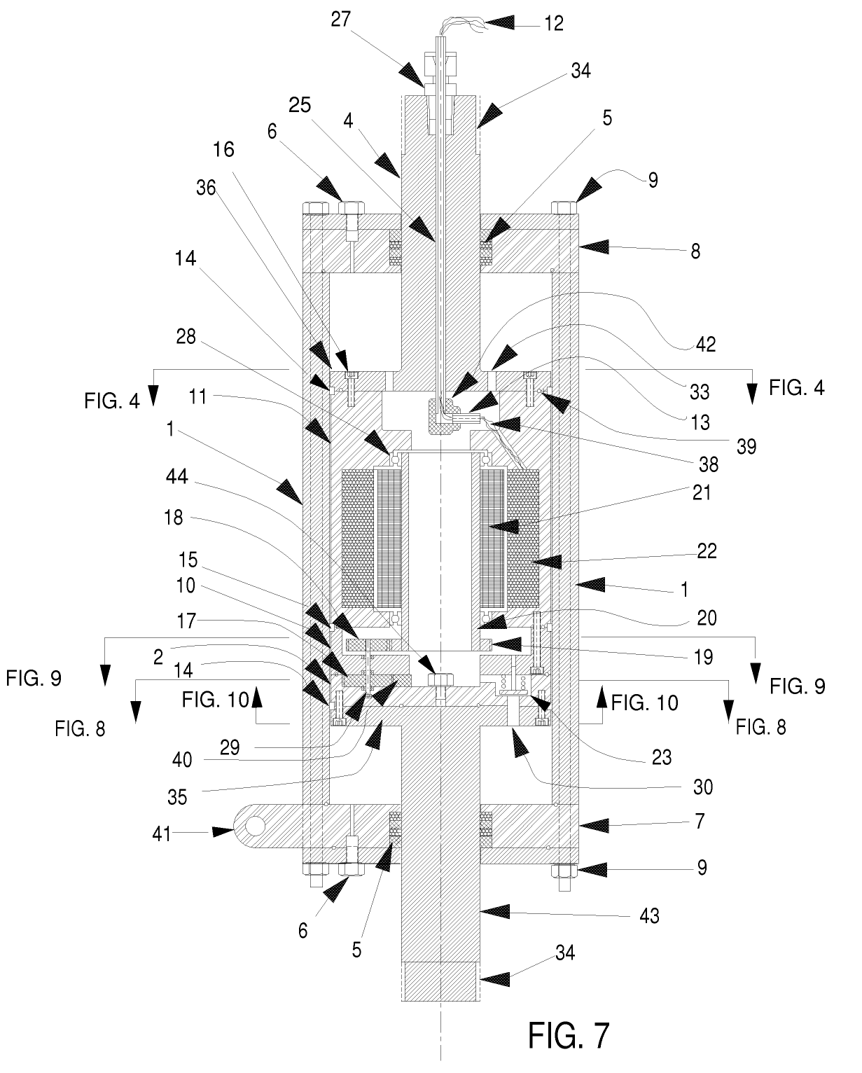

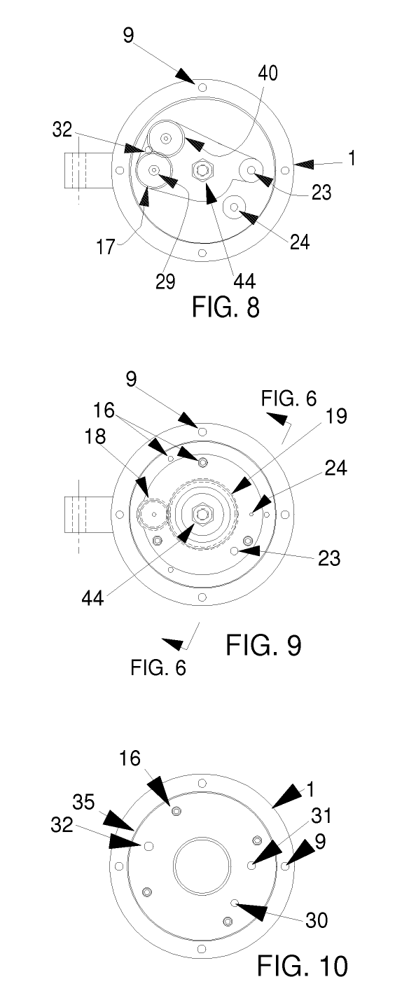

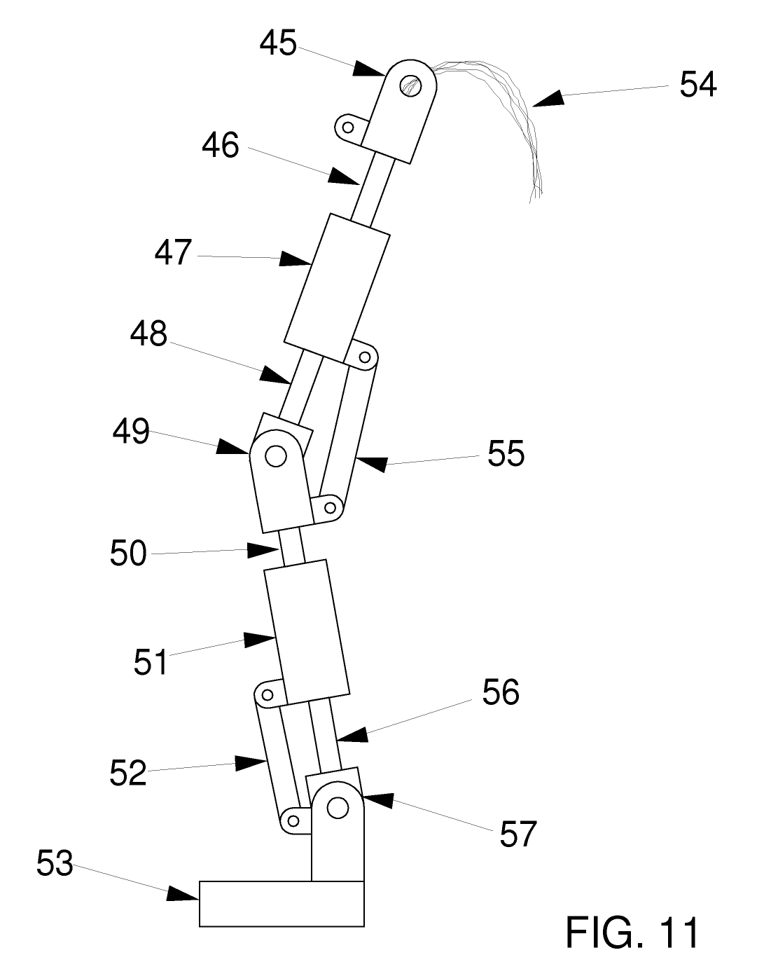

The preferred embodiment as shown in FIG. 1, consists of a Piston Assemble inside a Hydraulic Cylinder Assembly. The Piston Assembly comprises of a cylindrical ported Piston Housing Assembly with ported flanged piston rod shafts on both ends: Pump Side Rod Shaft (3); and Motor Side Rod Shaft (4).

The Piston Housing Assembly is the assembly of a Motor Housing (11) and a Pump Housing Assembly and external Piston Rings. The Pump Housing Assembly comprises a Pump Housing (2) and a Pump Rear Housing (10). The Pump Housing (2) contains the gear pump and relief valves. The gear pump consists of the pump gears: Pump Driving Gear (17); Pump Driven Gear (40) and their shafts and bearings (29). The relief valves consist of a Pump End to Motor End Pressure Relief Valve (23) and a Motor End to Pump End Pressure Relief Valve (24). The Pump End to Motor End Pressure Relief Valve (23) is ported through the pump housing (2) and through the Pump Side Rod Flange (35) by the Pump-End-to-Motor-End Pressure Relief Port (30). The Motor End to Pump End Pressure Relief Valve (24) is ported through the pump housing (2) and through the Pump Side Rod Flange (35) by the Motor-End-to-Pump-End Pressure Relief port (31). The motor side of the relief valves is ported to the inlet side of the gear pump to allow hydraulic fluid flow around the pump when the actuator is overloaded. The Pump Housing Assembly must be ridged enough to transmit the loads of the piston rods through the Housing. The Piston Rings includes Piston Pressure Rings (14) and Piston Rider Rings (15) on the outside diameter of the housing and are in sealing contact with the inside of the Hydraulic Cylinder (1).

The Motor consists of a Motor Housing (11), Motor Rotor (21) and Motor Stator (22). The Motor Rotor (21) would consist of magnetic material aligned and mounted on the hollow Motor Shaft (20). The Motor Rotor is secured for rotary motion by rotary bearings (28) on both ends of the shaft. The Motor Stator (22) would consist of coils of insulated wire wound on iron or iron based alloy metal, such as steel, and aligned and mounted to the Motor Housing (11) to most effectively apply magnetic forces to the poles of the Motor Rotor (21) Magnets and cause controlled rotary motion of the Motor Rotor when coils of the Motor Stator are energized in a controlled way by the motor driver circuitry of the external motion controller. The Motor Housing must be ridged enough to transmit the loads of the piston rods through the Housing.

The Motor Side Rod Shaft (3) has a hollow center and is equipped with tubing to contain wiring to the Motor Stator (22), sensors and, for the Feed-through Actuator, wiring passing through the Feed-through Actuator to other equipment. The tubing is sealed at the end of the rod with the Tubing Connector (27). The tubing is connected to a Tubing Tee Connector (26) for the Feed-through Actuator, or a Tubing Elbow (42) for the Non-feed-through Actuator, to branch wiring to the Motor Stator and any required sensors. The wiring to the Motor Stator (22) and sensors passes through a High Pressure Electrical Feed-Through (13) to seal the tubing from the hydraulic fluid. For the Feed-through Actuator, the wiring passing through the Feed-through Actuator passes through the Tubing Tee Connector (26) to a second length of tubing leading to and through the Tubing Connector (27) on the Pump Side Rod Shaft (3). Both Rod Shafts (3 or 43 & 4) are to be externally threaded (34) for mechanical connection or mounting of the Actuator. The Motor Side Rod Flange (36) will be ported (see FIG. 4, (33)), to allow passage of the hydraulic fluid to and from the motor side end of the Actuator. The Pump Side Rod Flange (35) will be ported (see FIGS. 5 and 10, (30, 31, and 32) to allow passage of the hydraulic fluid to and from the Pump side end of the Actuator to the pump and relief valves.

The Hydraulic Cylinder Assembly consists of the Cylinder (1), Pump Side Cylinder Head (7), Motor Side Cylinder Head (8), and Cylinder Tie Rods (9). Cylinder (1) to have inside bore diameter to accommodate the outside diameter of the piston rings (14 & 15) of the Piston Assembly. Cylinder wall thickness and material properties are to be sufficient to contain the hydraulic forces inside the cylinder, and the forces of attached mechanisms.

The Pump Side Cylinder Head (7) and Motor Side Cylinder Head (8) contain the Rod Packing (5) sliding seals in sealing contact with the piston rods of the piston assembly. The Cylinder Heads (7 & 8) also contain port (6) for filling, and draining the cylinders. An external relief valve or a plug with a rupture disk should be utilized at one of the ports (6) for relief of overpressures due to rapid expansion of the hydraulic fluid due to heat from an electrical overload to the motor stator. The Cylinder Heads (7 & 8) are to be sealed to the Cylinder (1) using a resilient seal between the Cylinder heads and the Cylinder. One of the Cylinder Heads would have a mechanical connection (41) suitable to drive the attached mechanism of the specific application. The two Cylinder Heads (7 & 8) contain the Cylinder (1) and are secured by the Cylinder Tie Rods (9). Cylinder Tie Rods can pass axially through the Cylinder walls as shown in FIGS. 1 and 7, or be on the outside of the Cylinder walls, with extended Cylinder Heads as in typical tie rod cylinder design. The size, quantity, and placement of the Cylinder Tie Rods are to be determined by the internal and external forces on the actuator. The Rod Packing (5) to contain sufficient pressure rings, pressure seals, rod wipers, and wear rings to meet the demands of the application loads and environment and duty requirements.

An application example is the walking robot's leg assembly of FIG. 11, where the actuator's piston assembly, partially shown in items 46 and 48 for the first actuator and 50 and 52 for the second actuator, would act as the leg bone and the actuator's external cylinder, items 47 and 51, would act as the moving muscle and be attached by mechanical linkage 55 and 52 to a second actuator assembly or mechanism, and pivot at joints 49 and 57. The actuators would actuate the leg motion and be able to absorb the energy of a jump or fall that was received through the linkages 52 and 55. The actuator's wiring 54 feeds through joint 45, through hollow rod 46 and branches in the piston enclosed in cylinder 47 to the first actuator's motor and sensors. The remaining wiring passes through hollow rod 48, through joint 49 and through rod 50 to the motor and sensors of the second actuator. If there is additional wiring for the attached mechanism 53 and beyond, it would pass through hollow rod 56 and joint 57. Control of the actuators would be by closed loop motion controller utilizing position feed-back from external or internal position sensors or encoders. Actuators would be sized to accommodate the required loads. Internal motor components would be sized according to the load, speed, and duty requirements. Motor should include temperature sensors so unit can be shut down if temperatures exceed operating range of the motor. Additional sensors should include position feedback for the motion controller either from an internal device built into the Piston Assembly or external encoders.

I claim as my invention:

1. An electrically powered hydraulic actuating cylinder with double rod construction and hollow shaft electrical motor, gear pump, and pressure relief valves integral to the piston, with ports on both faces of the piston for passage of the hydraulic fluid though the piston as forced by the motor driven gear pump to the opposite side of the piston and with a hollow shaft rod for wiring to the motor.

2. An electrically powered hydraulic actuating cylinder with double rod construction and hollow shaft electrical motor, gear pump, and pressure relief valves integral to the piston, with ports on both faces of the piston for passage of the hydraulic fluid though the piston as forced by the motor driven gear pump to the opposite side of the piston and with two hollow shaft rods for wiring to the motor and axially through the assembly.
